(19) United States
(12) Patent Application Publication
(10) Pub. No.: US 2017/0109358 A1
(43) Pub. Date: Apr. 20, 2017

(54) METHOD AND SYSTEM OF DETERMINING ENTERPRISE CONTENT SPECIFIC TAXONOMIES AND SURROGATE TAGS

(71) Applicants: Krishna Kishore Dhara, Hyderabad (IN); Anil Jwalanna, Cupertino, CA (US)

(72) Inventors: Krishna Kishore Dhara, Hyderabad (IN); Anil Jwalanna, Cupertino, CA (US)

(21) Appl. No.: 14/884,054

(22) Filed: Oct. 15, 2015

(51) Int. Cl. G06F 17/30

(52) U.S. Cl. CPC G06F 17/3071; G06F 17/30684; G06F 17/30011

(57) ABSTRACT

In one aspect, a method of information retrieval from at least one computer database includes the step of providing a set of digital documents of an enterprise. The method include the step of providing a tag hierarchy, wherein the tag hierarchy comprises a specified hierarchy of keyword tags. The method includes the step of extracting a set of keywords from the set of digital documents. The method includes the step of clustering the set of keywords into a keyword duster using an is-a relationship and synsets method. For each keyword in the set of keywords the following steps are performed: selecting a keyword from the keyword cluster, determining that the keyword is in the tag hierarchy, labeling a document in the set of digital documents that includes the keyword with a tag from the keyword, adding the keyword tag to a document tag list. The method includes the step of rendering the document tag list in a searchable format.

### CROSS-REFERENCE TO RELATED APPLICATIONS

This application hereby incorporates by reference the following applications in their entirety: U.S. Provisional Patent Application No. 61/663,169, titled Cloud Based Content Management and filed on 22 Jun. 2012, and U.S. patent application Ser. No. 13/915,327, titled Method And System Of Cloud-computing Based Content Management And Collaboration Platform With Content Blocks, and filed on 26 Jun. 2013.

### FIELD OF THE INVENTION

The current invention relates to the fields of mining documents and identifying taxonomies that can be used for organizing the content and for searching the content. The current invention specifically addresses the issue of uniquely generating enterprise specific taxonomies rather than internet-scale or a more general taxonomies.

### DESCRIPTION OF THE RELATED ART

A general approach to organize content is to mine keywords, named entities, and lookup. For example, large repositories such as Wikipedia® can be categorized using a multi-domain ontology. Various sophisticated queries can be broken down based on the searched categories. This ontology can be developed over a time and often has an Internet-wide usage and derives from Internet-scale content. Taxonomy, which is part of an ontology, can be thought of hierarchical grouping of things, often as a tree structure.

One approach can be to extract key words or phrases out of unstructured content in a document and use an existing system obtain the taxonomy for the document. For example, given a document, its keywords can be extracted. The document can then be classified and/or organized in a hierarchy, such as, “science and technology”→“biology”, etc. or “sports”→“BasketBall”, etc. These types of taxonomies can be derived after reviewing a large set of documents and may be useful for internet scale searches or services or for organizing news articles, etc.

One problem with generic taxonomy can be seen M the following example. Consider an automobile manufacturing enterprise. Classifying its documents as “automobile” may be of no use as most documents are related to automobile in one way of other. Even classifying with the kind of “automobile” such as a “SUV”, etc., may not be useful because users of that enterprise use specific terms such as their model of the SUV to search the content. Hence, any taxonomy built on this enterprise corpus should reflect the specific word they use for SUV. This principle contradicts how generic taxonomies are created.

Hence, for enterprise this kind of generic taxonomy may not be useful as most enterprises, other than news organizations, etc., are specific to certain field or to a few fields. Categorizing the content and/or interpreting user queries using this generalized taxonomy is of limited use to most enterprises. An effective organization of enterprise content can be based on the terminology commonly used within the enterprise when content is created, the terminology used when the content is consumed or searched. A most commonly used specific term used in a particular enterprise to represent a generic term that is commonly used across a wider corpus. Current solutions that are based on generic taxonomies do not solve these problems. Accordingly, methods and systems of determining enterprise content specific taxonomies can improve upon the prior art.

Hidden or surrogate tags are often not identified in prior taxonomy based systems. That is if users of an enterprise use the terms “thermal”, “control”, “systems”, and a particular document uses only the terms “thermal” and “systems”, then the hidden tag “control” is considered as a surrogate tag. Though the example listed three terms it could be applicable two or more terms. We refer to these as “surrogate tags”. These surrogate tags do not occur in the document but are closely associated with terms in the documents of a particular enterprise.

These surrogate tags are often useful when new employees join a large organization and start authoring documents. Often, they are not adept at using the new organization's terminology. Even in that case, these documents need to be classified with the surrogate tags are identified and assigned appropriate enterprise taxonomy structure. Such classification and taxonomy structure will help in a) search and b) navigation. For example, if other users' search using common terminology of the enterprise then the results might not retrieve this new document at all or even if it is retrieved, it could be ranked low because of the missing surrogate tags. Similarly for navigation of the taxonomy, if the surrogate tag is the missing link, in the hierarchy and if it is not found then (other) enterprise users might not be able to navigate to this new document by the new employee. We need a new system to a) determine these surrogate tags and b) associate them with taxonomies.

Current systems do not generate enterprise specific taxonomy and are still dependent on words occurring in a document and hence do not capture related missing bridging words that are common in an enterprise, which could be to classify a document appropriately in an enterprise specific taxonomy.

### BRIEF SUMMARY OF THE INVENTION

In one aspect, a method of information retrieval from at least one computer database includes the step of providing a set of digital documents of an enterprise. The method include the step a providing a tag hierarchy, wherein the tag hierarchy comprises a specified hierarchy of keyword tags. The method includes the step of extracting a set of keywords from the set of digital documents. The method includes the step of clustering the set of keywords into a keyword cluster using an is-a relationship and synsets method. For each keyword in the set of keywords the following steps are performed: selecting a keyword from the keyword cluster, determining that the keyword is in the tag hierarchy, labeling as document in the set of digital documents that includes the keyword with a tag from the keyword, adding the keyword tag to a document tag list. The method includes the step of rendering the document tag list in a searchable format.

Optionally, the method includes the step of providing a provisional tag hierarchy. The method includes the step of determining that the keyword is in the provisional tag hierarchy. The method includes the step of increasing a weight of a link in the provisional tag hierarchy. The method includes the step of determining that the weight of the link achieves a specified. value. The method includes the step of adding the tag to the document tag list.

### BRIEF DESCRIPTION OF THE DRAWINGS

FIG. 1 illustrates a process to identify a taxonomy that is specific to an enterprise, according to some embodiments.

FIG. 2 depicts another process of identifying a taxonomy that is specific to an enterprise, according to some embodiments.

FIG. 3 depicts, in block diagram format, a taxonomy system, according to some embodiments.

FIG. 4 is a block diagram of a sample computing environment that can be utilized to implement some embodiments.

FIG. 5 is a block diagram of a sample computing environment that can be utilized to implement some embodiments.

FIG. 6 illustrates an example process of determining various enterprise specific taxonomies, according to some embodiments.

FIGS. 7 A-B illustrates a process of converting correlated words to generic terms that are appropriate for the enterprise to related terms in taxonomy.

The Figures described above are a representative set, and are not an exhaustive with respect to embodying the invention.

### DESCRIPTION

Disclosed are a system, method, and article of determining enterprise content specific taxonomies. The following description is presented to enable a person of ordinary skill in the an to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or Monitoring period of unspecified duration between enumerated steps of the depicted method. Additionally, the order in which a particular method occurs may or may not strictly adhere to the order of the corresponding steps shown.

Definitions

Cluster can be a grouping in a statistical population.

Cluster analysis (e.g. clustering) can be the task of grouping a set of objects in such a way that objects in the same cluster are more similar to each other than to those in other clusters.

Bigram can be a sequence of two adjacent elements in a string of tokens, which are typically letters, syllables, or words (e.g. n-grams for n=2).

DBpedia can be a project aiming to extract structured content from the information created as part of the Wikipedia project.

‘is-a’ relationship can be a subsumption relationship (e.g. a hyponym-hypernym relationship, etc.) between abstractions (e.g. types, classes, etc.), where one class A is a subclass of another class B (and so B is a superclass of A).

Synset (e.g. synonym ring) can be a group of data elements that are considered semantically equivalent for the purposes of information retrieval.

Tag can represent keywords or phrases that are either generic and/or used in documents enterprise.

Taxonomy can include the practice and science of classification of things or concepts, including the principles that underlie such classification.

### Example Methods

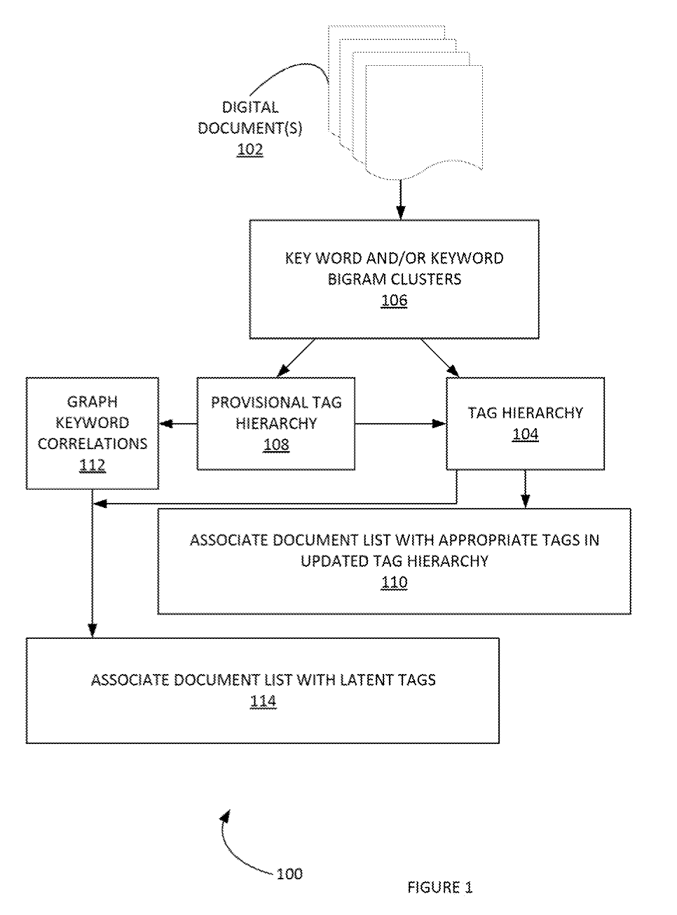

FIG. 1 illustrates a process 100 to identify a taxonomy that is specific to an enterprise, according to some embodiments. An enterprise can use process 100 to build a taxonomy to be used for elective searching by its users. Process 100 can organize documents based on tags and/or key phrases from the taxonomy. A tag can represent a keyword and/or a phrase that is either generic and/or used in documents in an enterprise. In process 100, a set of documents 102 and a tag hierarchy 104 can be obtained. It is noted that tag hierarchy 104 can be empty at this point. Process 100 can outline the association of tags to documents and the auto generation of new tag labels. Process 100 can process each document and extract keywords and/or bigrams (and/or other specified n-gram) of keywords for co-occurrence. In step 106, the keywords and/or bigram keywords can be clustered using a “is-a” relationship and/or “synsets” methods. For each of the keywords and/or bigram keywords, a representative from the corresponding cluster ‘t’ can be selected. A graph of these correlated cluster ‘t’ words is generated. This graph represents co-occurrence of pairs of words across all documents.

If cluster ‘t’ is represented in tag hierarchy 104, then process 100 can label document with the tag from the keyword and continue to next keyword/bigram. The corresponding tag to a document tag list. In step 110, process 100 can associate document list with appropriate tags in updated tag hierarchy.

If cluster ‘t’ is in provisional tag hierarchy 108, then process 100 can increase the weight of link in provisional tag hierarchy 108 is strengthened. Process 100 can then check the provisional tag hierarchy 108 to determine if the link strength is higher than a threshold and insert that into tag hierarchy 104 and add the corresponding tag to the document tag list. The documents tag list can represent the tag clusters that the document belongs to. The documents tag, list can be used in indexing and/or navigation operations. Key word correlations can be graphed in step 112.

If there is a path from node cluster ‘t’ to any other node in the graph, such that all the links are strong with respect to a threshold, then the nodes in the path that are not the document but are in the tag tree can be selected. These nodes can be for the surrogate tags for the document. Surrogate tags can be used to enable other users to retrieve documents that omitted the term in a particular document as it is used in other documents, especially by new employees that may not start using appropriate enterprise terminology yet. These tags can be derived from taxonomy tree that are specific to an enterprise and often can search documents with terms that are not associated or occur in the document. Finally, in step 114, process 100 can associate document list with surrogate tags.

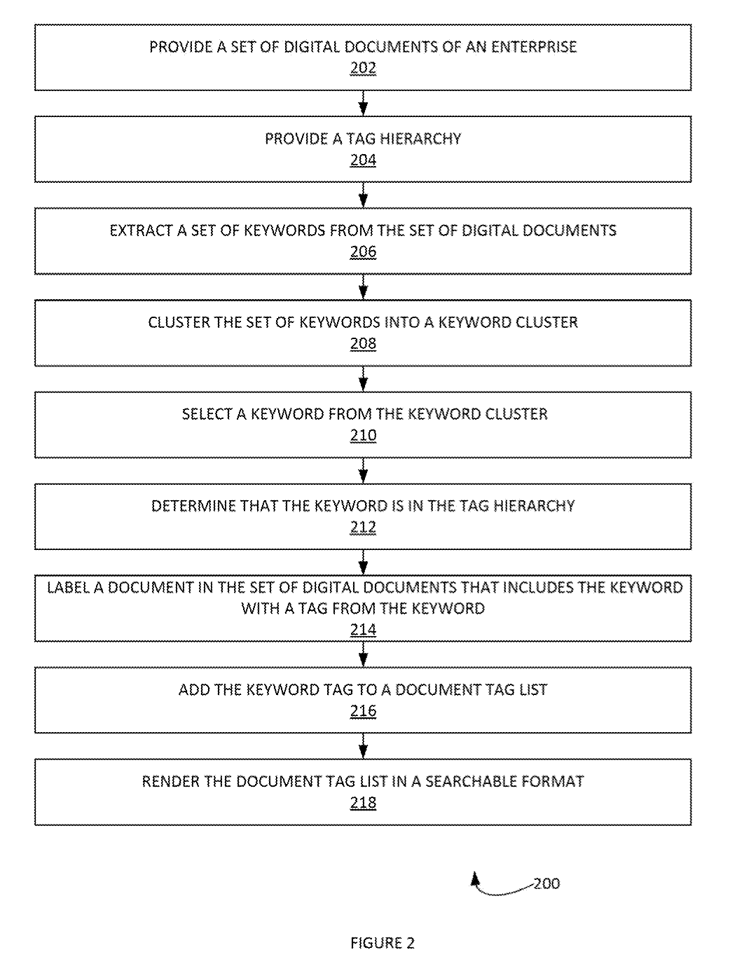

FIG. 2 depicts another process 200 of identifying a taxonomy that is specific to an enterprise, according to some embodiments. In Step 202, process 200 provides a set of digital documents of an enterprise. In step 204, process 200 provides a tag hierarchy. In step 206, process 200 extracts a set of keywords from the set of digital documents. Cluster the set of keywords into a keyword cluster. In step 210, process 200 selects a keyword from the keyword cluster. In step 212, process 200 determines that the keyword is in the tag hierarchy. In step 214, process 200 labels a document in the set of digital documents that includes the keyword with a tag from the keyword. In step 216, process 200 adds the keyword tag to a document tag list. In step 218, process 200 renders the document tag list in a searchable format.

Furthermore, process 200 can provide a provisional tag hierarchy. Process 200 can determine that the keyword is in the provisional tag hierarchy. Process 200 can increase a weight of a link in the provisional tag hierarchy. Process 200 can determine that the weight of the link achieves a specified value. Process 200 can add the tag to the document tag list.

Process 200 can graph the key word correlations. Nodes in the graph corresponds to (key)words occurring in the document corpus. The edges and the edge weight indicate the co-occurrence and the weight of the occurrence across all documents. The weight can be a function of the co-occurrence, such as if it is in the title or body, and the co-occurring words, such as are they key-words and the rarity of the co-occurrence across documents, etc. Hence, the edge weight represents the strength of the co-occurrence within an enterprise.

If in a document, an extracted keyword phrase corresponds to a path where most of the words match, then the missing nodes in the path can be picked as the surrogate tags and identified as tags. These surrogate tags are associated with documents and are also used to strengthen the tag hierarchy (taxonomy) that is specific to this enterprise. A surrogate tag is used to enable another user to retrieve at least one document that omitted the surrogate term in a particular document as it is used in other documents. Process 200 can associate the document tag list that includes surrogate tags.

Example Systems and Computer Architectures

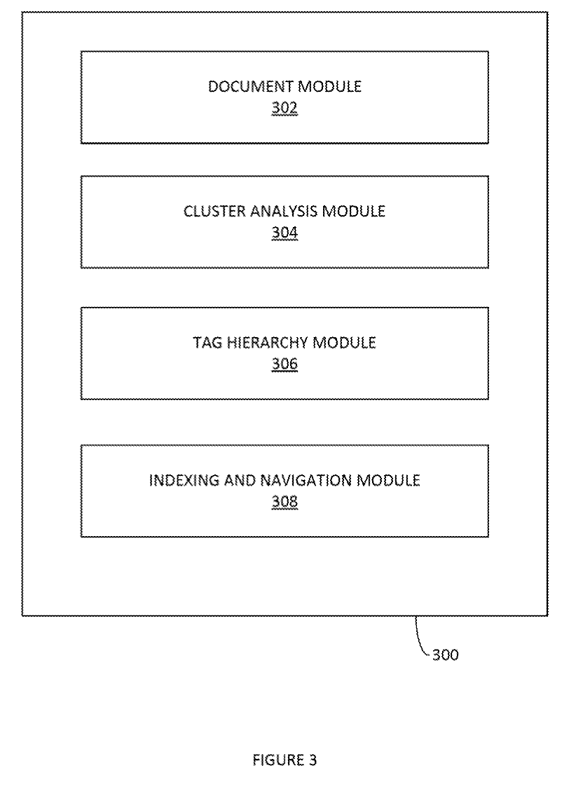

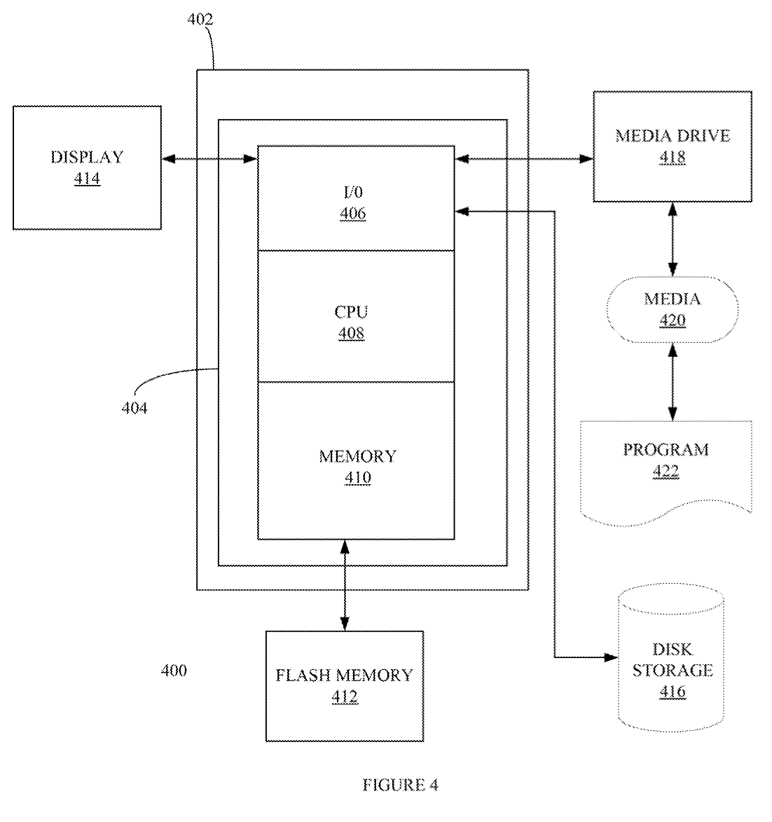

FIG. 3 depicts, in block diagram format, a taxonomy system 300, according to some embodiments. Taxonomy system 300 can determine enterprise content specific taxonomies. Taxonomy system 300 can organize of documents based on tags and/or key phrases from the taxonomy. Taxonomy system 300 can reflects an enterprise preferred use of terminology to build a taxonomy that could be used for effective searching by its users. Documents module 302 can obtain a set of documents to be analyzed by taxonomy system 300. Documents module 302 an also obtain other information such as relevant tags, etc.

Cluster analysis module 304 can cluster various units of a documents (e.g. words, n-grams, phrases, etc). In one example, cluster analysis module 304 can cluster keywords and/or bigram keywords using a “is-a” relationship and/or “synsets” methods. Cluster analysis module 304 can implement various clustering models. Example clustering modules can include, inter alia: connectivity models, centroid models, distribution models, subspace models, graph-based models, etc. It is noted that both hard and fuzzy clustering methods can be utilized.

Tag hierarchy module 306 can implement tag hierarchy-related operations such as those provide in processes 100 and 200 supra. For example, tag hierarchy module 306 can determine if a cluster is represented in a particular tag hierarchy. Indexing and navigation module 308 can utility keyword tags generated by taxonomy system 300 for various indexing and navigation operations.

FIG. 4 depicts an exemplary computing system 400 that can be configured to perform any one of the processes provided herein. In this context, computing system 400 may include, for example, a processor, memory, storage, and I/O devices (e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related, to it. The I/O section 406 can be connected to a display 414, a keyboard and/or other user input (not shown), a disk storage unit 416, and a media drive unit 418. The media drive unit 418 can read/write a computer-readable medium 420, which can include programs 422 and/or data. Computing system 400 can include a web browser. Moreover, it is noted that computing system 400 can be configured to include additional systems in order to fulfill various functionalities. Computing system 400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication, protocol, etc.

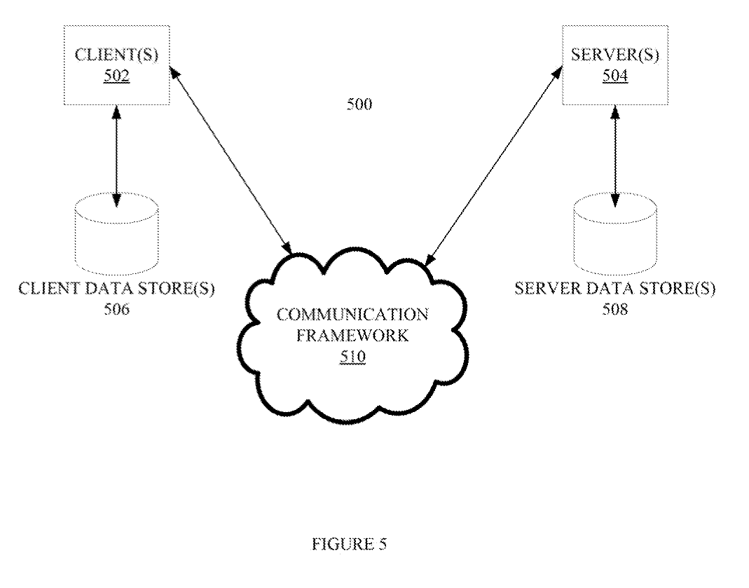

FIG. 5 is a block diagram of a sample computing, environment 500 that can be utilized to implement some embodiments. The system 500 further illustrates a system that includes one or more client(s) 502. The client(s) 502 can be hardware and/or software (e.g., threads, processes, computing devices). The system 500 also includes one or more server(s) 504. The server(s) 504 can also be hardware and/or software (e.g., threads, processes, computing devices). One possible communication between a client 502 and a server 504 may be in the form of a data packet adapted to be transmitted between two or more computer processes. The system 500 includes a communication framework 510 that can be employed to facilitate communications between the client(s) 502 and the server(s) 504. The client(s) 502 are connected to one or more client data store(s) 506 that can be employed to store information local to the client(s) 502. Similarly, the server(s) 504 are connected to one or more server data store(s) 508 that can be employed to store information local to the server(s) 504.

In some embodiments, system 500 can be include and/or be utilized by the various systems and/or methods described herein to implement any of the process and/or examples provided supra. Client 502 can be in art application (such as a web browser, augmented reality application, text messaging application, email application, instant messaging application, etc.) operating on a computer such as a personal computer, laptop computer, mobile device (e.g. a smart phone) and/or a tablet computer. In sonic embodiments, computing environment 500 can be implemented with the server(s) 504 and/or data store(s) 508 implemented in a cloud computing environment.

Additional Processes

It is noted that, in some embodiments, the term taxonomy can be used to loosely classify a tag hierarchy as a tree (or forest) structure with generic terms as nodes and “is-a” relationship capturing the parent-child relationship. The process provided herein can automatically identify tags, build, a taxonomy, and assign tags/taxonomy to individual documents in a corpus based on the enterprise specific usage of the terms.

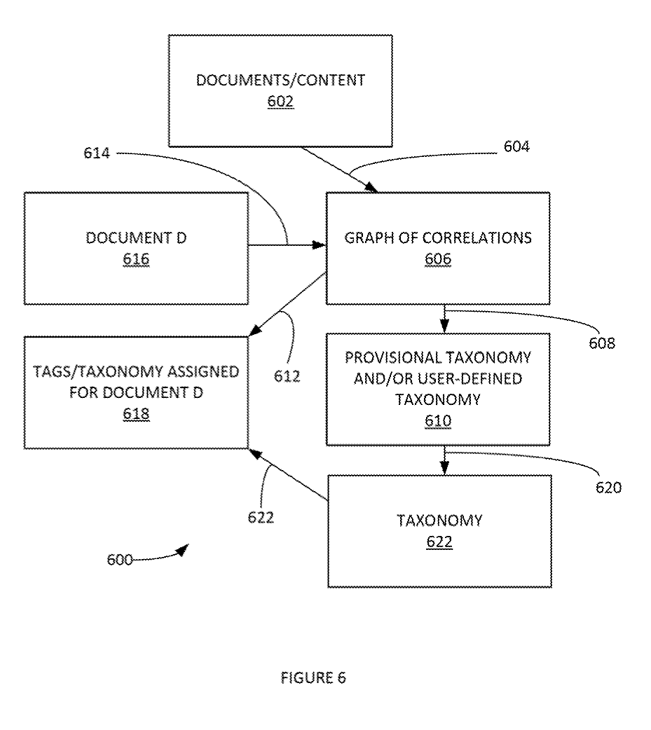

FIG. 6 illustrates an example process 600 of determining various enterprise specific taxonomies, according to some embodiments. Process 600 can mine documents to obtain a taxonomy that is tailored to a particular enterprise. In elements 602, 606, 610 and 622, document D 616 in the corpus and/or a new document can be added to the corpus and assigned appropriate tags for classification that are based on the taxonomy. This assignment can be used in both search and navigation. In step 604, process 600 converts the keyword correlations of all documents 602 into a graph of correlations 604 (e.g. represented by the entire graph). In step 608, process 600 converts the graph of correlations into provisional taxonomy and/or a user defined taxonomy 610. The nodes of this graph ca be keywords in their canonical form that capture the enterprise terminology. Step 620 illustrates how a taxonomy 622 can be created using provisional taxonomy and/or a user-defined taxonomy 610 by process 600. In steps 612 and 622, process 600 uses the graph of correlations 606 and taxonomy 622 to generate the tags/taxonomy assigned for document. D 618.

Process 600 can be to create nodes in the taxonomy tree, provisional or otherwise, is to identify nodes in the graph that have high connectivity and get the relationship of the correlation. For example, for a pair of highly connected nodes in the graph such as “output” and “fidelity”, can resolved to its most generic relationship to create a node in the taxonomy as “speaker” or “sound system” based on user defined taxonomy. That is, a set of matched generic “is-a” relations (e.g. from DBPedia and/or standard ontology based systems), then process 600 can filter the relations using either the taxonomy term from the user defined taxonomy of that enterprise and/or with an equivalent term that is often used in the enterprise. Accordingly, process 600 can build a taxonomy that is closer to the terminology used in art enterprise rather than depending on the external, too generic, ontology systems.

The provisional tree of 610 can capture relations that are significant but not quite strong to be pushed into the actual taxonomy structure. As more documents are added to the system, with more evidence, the provisional tree can push nodes to the actual taxonomy tree if the edge strength crosses certain threshold. It is noted that these nodes can be pushed at an appropriate level in the actual taxonomy tree. Elements 616 and 618 of process 600 illustrate assigning auto rags/taxonomy structure to a document. For each old or new document the steps described supra can be followed that builds upon the original, provisional, and/or user-defined taxonomy trees. Once complete, then the subgraph that matches this particular document can be projected onto the final taxonomy tree using the canonical form. The projected subtree can then be used as the taxonomy for this document D for organizing, search, and/or for navigation.

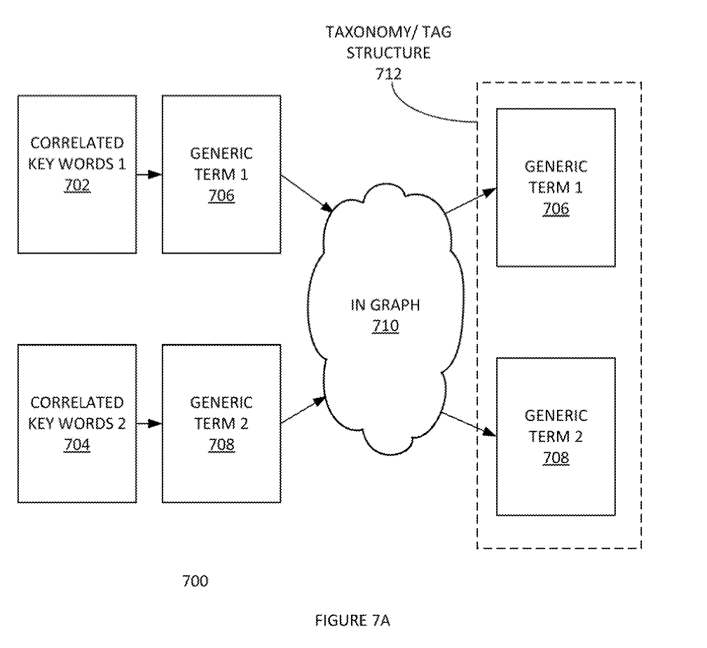

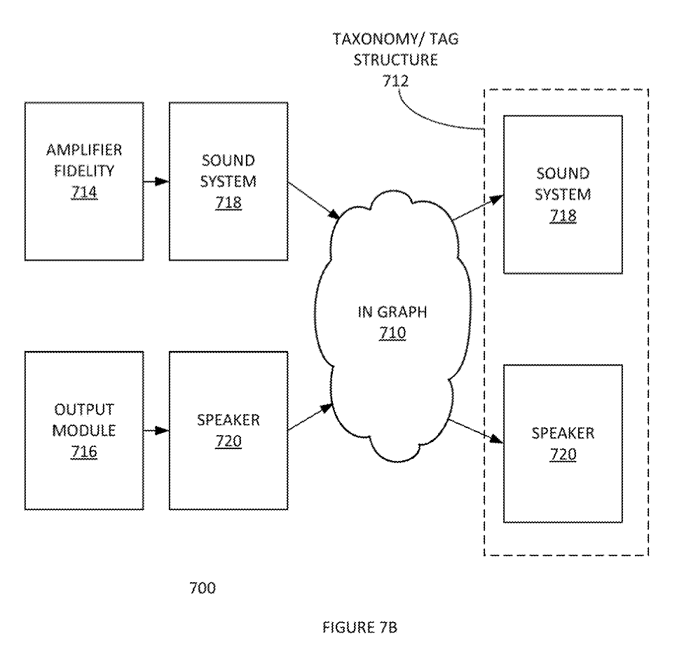

FIGS. 7 A-B illustrates a process 700 of converting correlated words to generic terms that are appropriate for the enterprise to related terms in taxonomy. Process 700 can be used for obtaining a canonical form. Process 700 can further elaborate various steps of process 600. For each keyword or correlated keywords we obtain a generic term (e.g. either using DBPedia or other such ontologies) and filtering the results using terms in the user-defined taxonomy For each co-occurrence of such generic words in documents, process 700 can strengthen the edge between them in the graph (e.g. as provided in process 600). Using this strength and the closest generic term for that enterprise we generate a taxonomy tree (e.g. as described in FIG. 6). More specifically, FIG. 7A illustrates a generic version of process 700. Correlated key words 702 and 704 can be used to determine generic terms 706 and 708. Generic terms 706 and 708 can be included in a graph of correlations 710 (e.g. as provided supra). Generic terms 706 and 708 can then be included in a taxonomy and/or tag structure 712.

FIG. 7B illustrates an example application of process 700. Correlated key words ‘amplifier fidelity’ 714 and ‘output module’ 716 can be used to determine generic terms ‘sound system’ 718 and ‘speaker’ 720. Generic term ‘sound system’ 718 and ‘speaker’ 720 can be included in a graph of correlations 710 (e.g. as provided supra). FIG. 78 shows an example with an edge count 55 that indicates the co-occurrence of “output module” and “amplifier fidelity” in documents of certain enterprise. Based on their corpus, any standard ontology system, and on the user-defined ontology, process 700 can translate them, for example, to “sound system” and “speaker” respectively. The count ‘55’ can indicates a score of how many times they occurred or how many times similar keywords occurred. Generic terms ‘sound system’ 718 and ‘speaker’ 720 can be included in a graph of correlations 710 (e.g. as provided supra).

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system), and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of information retrieval comprising:
providing a set of digital documents of an enterprise;
providing a tag hierarchy, wherein the tag hierarchy comprises a specified hierarchy of keyword tags;
extracting a set of keywords from the set of digital documents;
clustering the set of keywords into a keyword cluster using an is-a relationship and synsets method;
for each keyword in the set of keywords:
selecting a keyword from the keyword cluster,
determining that the keyword is in the tag hierarchy,
labeling a document in the set of digital documents that includes the keyword with a tag from the keyword,
adding the keyword tag to a document tag list;
rendering the document tag list in a searchable format.

2. The method of claim 1 further comprising:
providing a provisional tag hierarchy;
determining that the keyword is in the provisional tag hierarchy;
increasing a weight of a link in the provisional tag hierarchy;
determining that the weight of the link achieves a specified value; and
adding the tag to the document tag list.

3. The method of claim 2, wherein a tag represents a keyword or phrase that is used in the set of documents in the enterprise.

4. The method of claim 3, wherein the tag hierarchy is empty.

5. The method of claim 4, wherein the step of extracting keywords further comprises:
extracting a set of bigrams of keywords for co-occurrence.

6. The method of claim 5, wherein the step of clustering the set of key words further comprises:
clustering the set of bigrams of keywords using a is-a relationship and synsets method.

7. The method of claim 6, wherein the document tag list is used for used for an indexing operation.

8. The method of claim 7, wherein the document tag list is used for a navigation operation.

9. The method of claim 1 further comprising:
graphing the key word correlations, wherein each node of the graph of key word correlations can be used to derive surrogate tags for the document.

10. The method of claim 9, wherein a surrogate tag is used to enable another user to retrieve at least one document that omitted the surrogate term in a particular document as it is used in other documents.

11. The method of claim 10, wherein a surrogate tag is derived from taxonomy tree.

12. The method of claim 11 further comprising:
associating the document tag list with surrogate tags.

13. A system useful in organization data for retrieval in a computing system, the System comprising:
a computer store containing data, for a set of digital documents of an enterprise, providing a tag hierarchy, wherein the tag hierarchy comprises a specified hierarchy of keyword tags and graphing a set of key word relations;
a computer server, which computer server is coupled to the computer store and programmed to:
extract a set of keywords from the set of digital documents;
cluster the set of keywords into a keyword cluster using an is-a relationship and synsets method;
for each keyword in the set of keywords:
select a keyword from the keyword cluster,
determine that the keyword is in the tag hierarchy,
label a document in the set of digital documents that includes the keyword with a tag from the keyword,
add the keyword tag to a document tag list;
render the document tag list in a searchable format;
graph the key word correlations, wherein each node of the graph of key word correlations can be used to derive surrogate tags for the document, wherein a surrogate tag is used to enable another user to retrieve at least one document that omitted the surrogate term in a particular document as it is used in other documents, and wherein a surrogate tag is derived from taxonomy tree; and
associate the document tag list with surrogate tags.

14. The system of claim 13, wherein an extracted keyword phrase corresponds to a path where most of the words match, then the missing nodes in the path can be picked as the surrogate tags and identified as tags.

15. The system of claim 14, wherein the surrogate tag is associated with documents and are also used to strengthen the tag hierarchy that is specific to the enterprise.

16. The system of claim 15, wherein the surrogate tau enables another user to retrieve at least one document that omitted the surrogate term in a particular document as it is used in other documents.
